(19) United States
(12) Patent Application Publication
(10) Pub. No.: US 2024/0211671 A1
(43) Pub. Date: Jun. 27, 2024

(54) FAULT-TOLERANT ORIENTED PHYSICAL DESIGN METHOD FOR FULLY PROGRAMMABLE VALVE ARRAY BIOCHIPS

(71) Applicant: FUZHOU UNIVERSITY, Fuzhou (CN)

(72) Inventors: Genggeng LIU, Fuzhou (CN); Yuhan ZHU, Fuzhou (CN); Wenzhong GUO, Fuzhou (CN); Xing HUANG, Fuzhou (CN)

(73) Assignee: FUZHOU UNIVERSITY, Fuzhou (CN)

(21) Appl. No.: 18/238,566

(22) Filed: Aug. 28, 2023

Related U.S. Application Data
(63) Continuation of application No. PCT/CN2023/089662, filed on Apr. 21, 2023.

(30) Foreign Application Priority Data
Dec. 14, 2022 (CN) 202211605327.2

(51) Int. Cl. G06F 30/392; G06F 30/394

(52) U.S. Cl. CPC G06F 30/392; G06F 30/394; G06F 2111/06

(57) ABSTRACT

A fault-tolerant oriented physical design method for fully programmable valve array biochips is provided. The method comprises the following steps: step S1: constructing component placement constraints, and performing dynamic fault-tolerant placement based on a dynamic constraint placement algorithm of particle swarm optimization and in combination with dynamic fault-tolerant technology, thereby obtaining a fault-tolerant placement scheme without component conflicts; step S2: considering an input sequence of reagents and an A* fault-tolerant routing algorithm based on an optimal input sequence, performing dynamic fault-tolerant routing in combination with the dynamic fault-tolerant technology; and step S3: further processing fluid conflicts in the routing through a routing optimization strategy based on priority and backtracking, so as to obtain a fault-tolerant routing scheme without fluid conflicts.

### CROSS REFERENCE TO THE RELATED APPLICATIONS

This application is a continuation application of International Application No. PCT/CN2023/089662, filed on Apr. 21, 2023, which is based upon and claims priority to Chinese Patent Application No. 202211605327.2, filed on Dec. 14, 2022, the entire contents of which are incorporated herein by reference.

### TECHNICAL FIELD

The present invention relates to the technical field of computer aided design of microfluidic biochips, and in particular relates to a fault-tolerant oriented physical design method for fully programmable valve array biochips.

### BACKGROUND

As a new generation of fluidic microfluidic biochip, a Fully Programmable Valve Array (FPVA) biochip has become a popular platform for biochemical experiments. It combines advantages of traditional flow-based and digital microfluidic biochips and performs a fluid operation based on a channel and valve structure. It provides both programmability and high flexibility. As shown in FIG. 1, the FPVA biochip consists of intersecting flow channels with independent addressable valves regularly arranged in an array form. Fluid is flexible transported and component is dynamically constructed in any area of the FPVA by switching states of the valves. Architecture synthesis design processes of the FPVA biochip are classified into high-level synthesis and physical design. The physical design stage, as the most critical stage, comprises a component placement and flow channel routing. It determines a basic flow channel network of the chip, thus affecting overall performance of the chip. Therefore, in order to improve the quality and efficiency of the FPVA biochip, an efficient physical design automation scheme is indispensable. In addition, due to environmental or human factors, it is usually inevitable to have some manufacturing defects in a manufacturing process, such as channel fracture, dislocation, accidental connection, etc. These faults may lead to a failure of bioassay, which greatly increases a cost of chip manufacturing, and even causes a danger. However, no fault-tolerant algorithm has been proposed for these faults on the FPVA biochip. Therefore, a fault-tolerant design is essential to ensure a correct execution of on-chip bioassay.

### SUMMARY

In view of this, the purpose of the present invention is to provide a fault-tolerant oriented physical design method for fully programmable valve array biochips, aiming to solve the above problems.

To achieve the above object, the following technical scheme is adopted herein.

A fault-tolerant oriented physical design method for fully programmable valve array biochips, wherein the method comprises the following steps:
step S1: constructing component placement constraints, and performing dynamic fault-tolerant placement based on a dynamic constraint placement algorithm based on particle swarm optimization combined with a dynamic fault-tolerant technology, thereby obtaining a fault-tolerant placement scheme without component conflicts;
step S2: considering an input sequence of reagents, and performing dynamic fault-tolerant routing based on an A* fault-tolerant routing algorithm based on an optimal input sequence combined with a dynamic fault-tolerant technology; and
step S3: further processing fluid conflicts occurring in the routing through a routing optimization strategy based on priority and backtracking, thereby obtaining a fault-tolerant routing scheme without fluid conflicts.

Further, the component placement constraints specifically comprise:
a non-overlapping constraint set of components is introduced to limit two components to be overlapped, so as to prevent parallel components from occupying the same cell:

$$\begin{matrix}{x}_{id}^{i} \geq {x}_{ru}^{j} - {c}_{1} \times K & ( 1 ) \\ {x}_{ri}^{i} \leq {x}_{id}^{i} + {c}_{2} \times K & ( 2 ) \\ {y}_{id}^{i} \geq {y}_{ru}^{j} - {c}_{3} \times K & ( 3 ) \\ {y}_{ri}^{i} \leq {y}_{id}^{i} + {c}_{4} \times K & ( 4 ) \\ {\sum }_{k = 1}^{4} {c}_{k} = 3 & ( 5 )\end{matrix}$$

wherein, (x_{id}ⁱ, y_{id}ⁱ) and (xᵣᵤⁱ, yᵣᵤⁱ) represent lower-left and upper-right coordinates of the components bound by an operation Oᵢ respectively, and K is a maximum constant; and cₖ is an auxiliary binary variable, wherein k=1, 2, 3, 4; and, when cₖ is 0, a corresponding constraint is satisfied;
a component overlapping permission is introduced to allow the components to overlap so that an intermediate fluid can proceed to a next operation without transport; the component overlapping permission is implemented by adding an auxiliary binary variable c₅ in (5):

$${\sum }_{k = 1}^{4} {c}_{k} = 3 + {c}_{5} \qquad ( 6 )$$

c₅ is set to be 1 when two components are not concurrent, in which case, each CL k=1, 2, 3, 4 must be 1 to allow the two devices to overlap.

Further, the dynamic constraint placement algorithm of particle swarm optimization specifically comprises:
each particle is encoded as (pos₁, ⋅ ⋅ ⋅ , posₙ, f), wherein n is the number of components, posᵢ represents location information of a component Mᵢ, which is uniquely determined by the lower-left coordinate and shape of the component, and f represents an adaptation value of particles, then:
(1) an adaptation value function is defined as follows:

$$Fitness = {α}_{1} \times OL - {α}_{2} \times A - {α}_{3} \times D - β \qquad ( 7 )$$

wherein, OL is the number of overlapping cells of parent-child components, A is a chip area occupied by non-parent-child components, D is a distance from an output fluid to an output port, α₁,α₂,α₃ are weights that add up to 1, and β is a penalty term for violating the component placement constraints, which is defined as follows:

$$β = \{ \begin{matrix}K , {\sum }_{k = 1}^{4} {c}_{k} = 4 ∧ {c}_{5} = 0 \\ 0 , else\end{matrix} \qquad ( 8 )$$

wherein K is a maximum constant, and

$${\sum }_{k = 1}^{4} {c}_{k} = 4 ∧ {c}_{5} = 0$$

represents overlapping of concurrent components;
(2) an optimal solution is iteratively searched in a solution space according to the adaptation value of particles; in each round of iterative search, particles are updated according to historical optimal solutions and a global optimal solution; and an updating formula of the ith particle Pᵢ^{t} in the t round of iteration is defined as follows:

$${P}_{i}^{t} = {C}_{2} ( {C}_{1} ( M ( {P}_{i}^{t - 1} , w ) , {c}_{1} ) {c}_{2} ) \qquad ( 9 )$$

wherein M represents a mutation operation, an inertia weight w represents a probability of particle mutation, and C₁ and C₂ represent a crossover operation between a particle and an individual historical optimal solution and a global optimal solution respectively, and learning factors c₁ and c₂ represent crossover probabilities between the particle and the individual historical optimal solution and the global optimal solution respectively;
(3) firstly, a speed update is carried out, and an update formula is defined as follows:

$${M}_{i}^{t} = M ( {P}_{i}^{t - 1} , w ) = \{ \begin{matrix}M ( {P}_{i}^{t - 1} , w ) , & {r}_{1} < w \\ {P}_{i}^{t - 1} , & else\end{matrix} \qquad ( 10 )$$

wherein r₁ is a random number within 0˜1; when r₁ is less than w, the particle mutates;
the mutation operation is as follows: a component is randomly selected and a new available cell is found for the component as a new placement location thereof;
secondly, self-cognitive learning is carried out, and an updated formula is defined as follows:

$${CP}_{i}^{t} = {C}_{1} ( {M}_{i}^{t} , {c}_{1} ) = \{ \begin{matrix}{C}_{1} ( {M}_{i}^{t} , {c}_{1} ) , & {r}_{2} < {c}_{1} \\ {M}_{i}^{t} , & else\end{matrix} \qquad ( 11 )$$

wherein r₂ is a random number within 0˜1; when r₂ is less than c₁, the particle is crossed with the individual historical optimal solution. the idea of the crossover operation of particle and individual historical optimal solution is as follows: the components that are in the same position between the current particle and individual historical optimal solution are kept, one component is randomly selected among the other components, and a new placement position is searched for the component;
finally, social experience learning is performed, and an update formula is defined as follows:

$${CG}_{i}^{t} = {C}_{2} ( {CP}_{i}^{t} , {c}_{2} ) = \{ \begin{matrix}{C}_{2} ( {CP}_{i}^{t} , {c}_{2} ) , & {r}_{3} < {c}_{2} \\ {CP}_{i}^{t} , & else\end{matrix} \qquad ( 12 )$$

wherein r₃ is a random number within 0˜1, and, when r₃ is less than c₂, the particle is crossed with the global optimal solution; and the idea of crossing the particle and the global optimal solution is the same as that of C₁.

Further, the fault-tolerant placement scheme without component conflicts specifically comprises:
(1) constructing a new alternative path by using standby cell thereof according to a bidirectional redundancy technology; and
(2) converting cells occupied by other components which have finished the operation into spare cells according to a cell function conversion technology, thus opening a passable path for the current fluid.

Further, the A* fault-tolerant routing algorithm based on an optimal input sequence specifically comprises:
considering a reagent input sequence and aiming to minimize bioassay completion time, a total length of transport path and the number of fluid conflicts, a formula (13) is used to calculate a new routing cost to increase a cost of routing scheme with fluid conflicts, which is calculated as:

$$G ( p ) = \{ \begin{matrix}( \vert {x}_{p} - {x}_{s} \vert + \vert {y}_{p} - {y}_{s} \vert ) \times l , \\ ( \vert {x}_{p} - {x}_{s} \vert + \vert {y}_{p} - {y}_{s} \vert ) \times 2 l , ∃\end{matrix} \qquad ( 13 )$$

wherein, (xₚ, yₚ) and (xₛ, yₛ) respectively represent coordinates of a current cell p and a starting point cell s, l represents a cell length passing through a FPVA cell, and cell(s, p) represents a set of routing cells passed through from the starting point cell s to the current cell p.

Further, the routing optimization strategy based on priority specifically comprises: fluid transport priorities are defined,
level 1: a fluid with earlier operating time;
level 2: a fluid further from a target component;
level 3: a fluid in a transport state;
level 4: a fluid that has been stored for a longer period of time;
in the event of a fluid conflict, a fluid with a lower priority would change direction or be stored in a standby cell, waiting for a fluid with a higher priority to preferentially pass.

Further, if a fluid is transported to a cell that is already occupied by another fluid, the fluid in the cell would pass through first, regardless of priority.

Further, the routing optimization strategy based on backtracking specifically comprises: the following procedure is repeated until conflicts are avoided: when a fluid conflict occurs at one moment, backtracking to a previous moment and searching for an available standby cell to store critical fluids, meanwhile, the remaining fluids continue to be transported according to the fluid transport priority.

Compared with the prior art, the present invention has the following beneficial effects: The present invention generates a fault-tolerant FPVA architecture that avoids all physical faults and potential conflicts, thereby achieving a physical design solution that minimizes the bioassay completion time and the total length of the transport path.

### BRIEF DESCRIPTION OF THE DRAWINGS

FIG. 1 shows a FPVA architecture and its topological connection diagram in an embodiment of the present invention;

FIG. 2 is a flow chart of a method of the present invention;

FIG. 3 is a multi-functional cell in an embodiment of the present invention;

FIG. 4 shows a bidirectional redundancy technology in an embodiment of the present invention; and

FIG. 5 shows a fault mapping technology in an embodiment of the present invention.

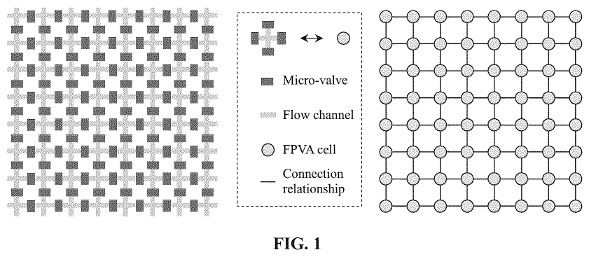

### DETAILED DESCRIPTION OF THE EMBODIMENTS

The present invention is further explained in combination with the accompany drawings and embodiments below.

In this embodiment, physical faults on an FPVA biochip are defined as faults arising from an environmental or die problem during a chip manufacturing procedure and are classified into the following four categories:
(1) Valve blocking: due to an accidental connection between control channels, air pressure is transmitted to a non-specified channel segment, resulting in a failure of a valve in the channel segment to be opened normally, thus blocking fluid transport.
(2) Valve leakage: the valve can not be closed normally, causing that fluid can not stay in the specified channel segment. The reasons for the fault comprise but are not limited to: 1) the control channel is blocked due to fracture of the control channel, an uneven wall of the control channel or dislocation of the control channel and a flow channel, and the air pressure cannot reach a specified position; 2) because the accidental connection between the control channels, the perforation of the channel wall and other factors lead to the leakage of the control channels, the air pressure reaching the specified position is insufficient; and, 3) the film forming the valve loses elasticity or the channel size does not match, causing that the valve formed cannot cover and seal the corresponding flow channel segment.
(3) Flow channel blocking: due to the fracture of flow channel, uneven wall of flow channel and other factors, resulting in flow channel blocking, and fluid can not pass through normally.
(4) Flow channel leakage: due to the accidental connection between flow channels, perforation of channel wall and other factors, resulting in the flow channel leakage, and fluid penetrates into other channel segments or loss.

In addition to physical faults, component and fluid conflicts in the physical design are two other factors that prevent the proper performance of bioassay.
(1) Component conflict: in a placement phase, a plurality of components occupy the same cell at the same time, or there are not enough spare cells to build a plurality of components at the same time, which would cause the component conflict.
(2) Fluid conflict: in a routing stage, a plurality of fluids are transported to the same cell at the same time, or one fluid is transported to a cell occupied by another fluid, which would cause the fluid conflict.

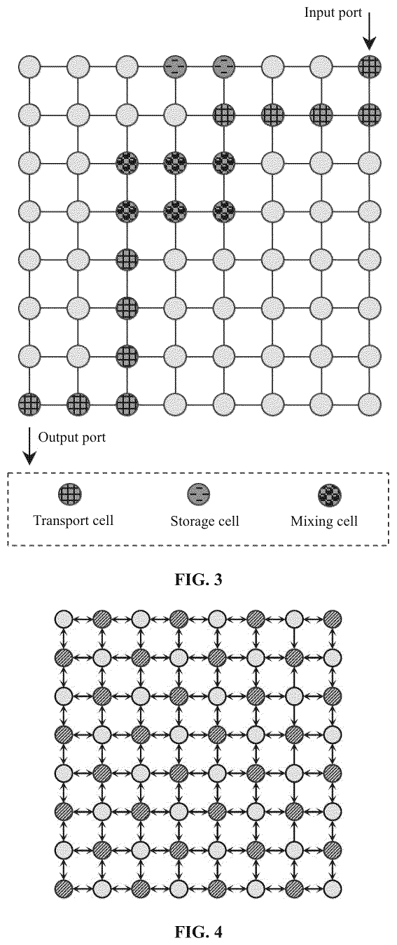

In the present embodiment, based on flexibility of the FPVA, the present invention introduces a concept of multi-functional cells and defines three functional cells, as shown in FIG. 3, comprising:
(1) Transport cell: by opening or closing a series of valves on the transport cell, a flow direction of fluid is guided to form a transport path, and the fluid is transported between an input/output port and components.
(2) Storage cell: the fluid is temporarily stored therein by closing all peripheral valves on the storage cell.
(3) Mixing cell: by opening an inner valve of the mixing cell and closing the peripheral valve, mixers of different sizes are dynamically constructed to drive the fluid to be mixed in it.

Based on the concept of multi-functional cell, this paper proposes the cell function transformation technology. In the process of bioassay, each cell can perform function transformation dynamically, so that the fluid can realize specific functions without additional transportation, such as dynamic reconfiguration of components and control of fluid state transformation.

In the present embodiment, based on the cell function transformation technology, the present invention designs a bidirectional redundancy technology, as shown in FIG. 4, which has the following characteristics:
(1) Adjacent FPVA cells serve as standby cells of each other, so that there are 2-4 standby cells around one FPVA cell.
(2) Each standby cell can replace any adjacent original cell functionally, and can realize different functions dynamically.

The bidirectional redundancy technology maximizes the utilization of all spare cells on the FPVA architecture, with standby resources available for each cell at no additional cost, thus enabling real-time fault-tolerant at the lowest cost.

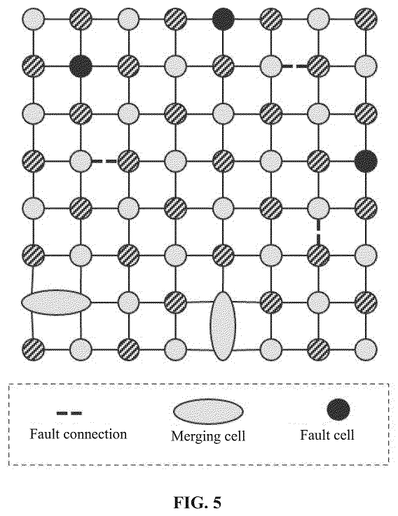

In this embodiment, combined with the fault-tolerant technology mentioned above, the present invention also proposes a fault mapping technology which takes into account different types and characteristics of physical faults and maps them to corresponding positions on the FPVA topological connection diagram according to the following rules to generate a fault mapping diagram, as shown in FIG. 5.
(1) Because the valve blocking fault represents the forbidden operation of the channel segment where the valve is located, the valve blocking fault is mapped as a fault connection.
(2) Because the valve leakage fault only affects the two cells connected to the valve, and except for the fault valve, the remaining valves in the two cells and all the channel segments are normal, the valve leakage fault is mapped to a merging cell.
(3) If the fluid passes through the channel segment with the channel blocking or channel leakage fault, it may lead to fluid loss or pollution, that is, the occurrence of channel blocking and channel leakage fault would cause the corresponding FPVA cell to be unusable. Therefore, the channel blocking and channel leakage are mapped to the fault cell.

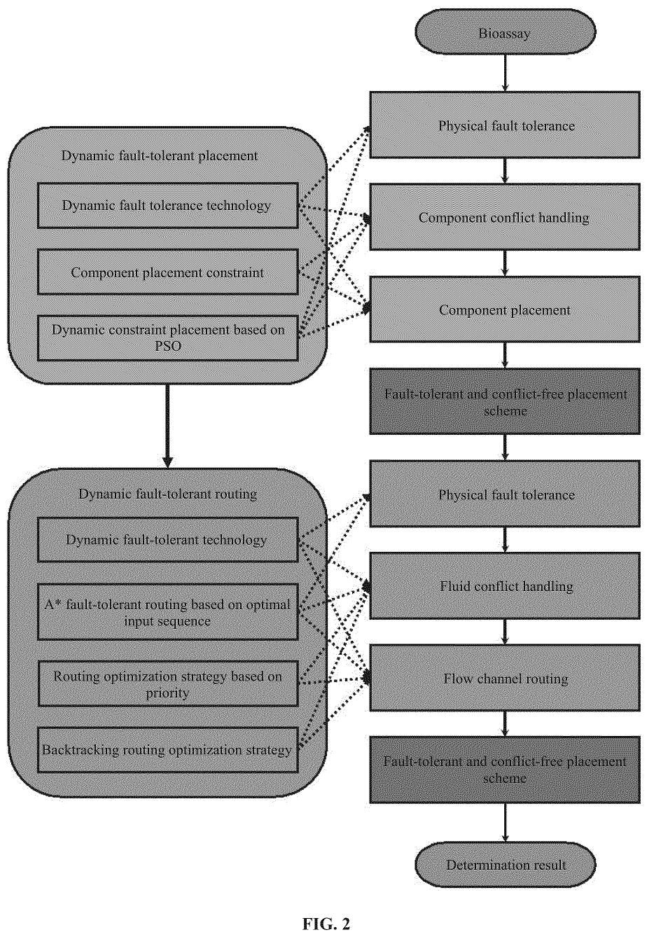

Referring to FIG. 2, the present invention provides a fault-tolerant oriented physical design method for fully programmable valve array biochips, wherein the method comprises the following steps:
step S1: constructing component placement constraints, and performing dynamic fault-tolerant placement based on a dynamic constraint placement algorithm based on particle swarm optimization combined with a dynamic fault-tolerant technology, thereby obtaining a fault-tolerant placement scheme without component conflicts;
step S2: considering an input sequence of reagents, and performing dynamic fault-tolerant routing based on an A* fault-tolerant routing algorithm based on an optimal input sequence combined with a dynamic fault-tolerant technology: and
step S3: further processing fluid conflicts occurring in the routing through a routing optimization strategy based on priority and backtracking, thereby obtaining a fault-tolerant routing scheme without fluid conflicts.

Preferably, in the present embodiment, the component placement constraints specifically comprise:
a non-overlapping constraint set of components is introduced to limit two components to be not overlapped, so as to prevent parallel components from occupying the same cell:

$$\begin{matrix}{x}_{id}^{i} \geq {x}_{ru}^{j} - {c}_{1} \times K & ( 1 ) \\ {x}_{ri}^{i} \leq {x}_{id}^{i} + {c}_{2} \times K & ( 2 ) \\ {y}_{id}^{i} \geq {y}_{ru}^{j} - {c}_{3} \times K & ( 3 ) \\ {y}_{ri}^{i} \leq {y}_{id}^{i} + {c}_{4} \times K & ( 4 ) \\ {\sum }_{k = 1}^{4} {c}_{k} = 3 & ( 5 )\end{matrix}$$

wherein, (x_{id}ⁱ, y_{id}ⁱ) and (xᵣᵤⁱ, yᵣᵤⁱ) represent lower-left and upper-right coordinates of the components bound by an operation Oᵢ respectively, and K is a maximum constant; and cₖ is an auxiliary binary variable, wherein k=1, 2, 3, 4; and, when cₖ is 0, a corresponding constraint is satisfied;

Because components can be constructed and reconfigured dynamically, the cell in which a component resides is transformed to a usable cell immediately after the operation bound by a component is completed. Therefore, when two components are not parallel, a component overlapping permission is introduced to allow the components to overlap so that an intermediate fluid can proceed to a next operation without transport, the component overlapping permission is implemented by adding an auxiliary binary variable c₅ in (5):

$${\sum }_{k = 1}^{4} {c}_{k} = 3 + {c}_{5} \qquad ( 6 )$$

c₅ is set to be 1 when two components are not concurrent, in which case, each cₖ, k=1, 2, 3, 4 must be 1 to allow the two devices to overlap.

Preferably, in this embodiment, the dynamic constraint placement algorithm of particle swarm optimization specifically comprises:
according to the location of component, a coding scheme is designed herein to encode each particle as (posᵢ, ⋅ ⋅ ⋅ , posₙ, f), wherein n is the number of components, posᵢ represents location information of a component Mᵢ, which is uniquely determined by the lower-left coordinate and shape of the component, and f represents an adaptation value of particles.
(1) an adaptation value function is defined as follows:

$$Fitness = {α}_{1} \times OL - {α}_{2} \times A - {α}_{3} \times D - β \qquad ( 7 )$$

wherein, OL is the number of overlapping cells of a parent-child component, A is a chip area occupied by non-parent-child components, D is a distance from an output fluid to an output port, α₁,α₂,α₃ are weights that add up to 1, and β is a penalty term for violating the component placement constraints, which is defined as follows:

$$β = \{ \begin{matrix}K , {\sum }_{k = 1}^{4} {c}_{k} = 4 ∧ {c}_{5} = 0 \\ 0 , else\end{matrix} \qquad ( 8 )$$

wherein K is a maximum constant, and

$${\sum }_{k = 1}^{4} {c}_{k} = 4 ∧ {c}_{5} = 0$$

represents overlapping of concurrent components;
(2) an optimal solution is iteratively searched in a solution space according to the adaptation value of particles; in each round of iterative search, particles are updated according to historical optimal solutions and a global optimal solution; and an updating formula of the ith particle Pᵢ^{t} in the t round of iteration is defined as follows:

$${P}_{i}^{t} = {C}_{2} ( {C}_{1} ( M ( {P}_{i}^{t - 1} , w ) {c}_{1} ) {c}_{2} ) \qquad ( 9 )$$

wherein M represents a mutation operation, an inertia weight w represents a probability of particle mutation, and C₁ and C₂ represent a crossover operation between a particle and an individual historical optimal solution and a global optimal solution respectively, and learning factors c₁ and c₂ represent crossover probabilities between the particle and the individual historical optimal solution and the global optimal solution respectively;
(3) firstly, a speed update is carried out, and an update formula is defined as follows:

$${M}_{l}^{t} = M ( {P}_{i}^{t - 1} , w ) = \{ \begin{matrix}M ( {P}_{i}^{t - 1} , w ) , & {r}_{1} < w \\ {P}_{i}^{t - 1} & else\end{matrix} \qquad ( 10 )$$

wherein r₁ is a random number within 0˜1; when r₁ is less than w, the particle mutates;
the mutation operation is as follows: a component is randomly selected and a new available cell is found for the component as a new placement location thereof;
secondly, self-cognitive learning is carried out, and an updated formula is defined as follows:

$${CP}_{i}^{t} = {C}_{1} ( {M}_{i}^{t} , {c}_{1} ) = \{ \begin{matrix}{C}_{1} ( {M}_{i}^{t} , {c}_{1} ) , & {r}_{2} < {c}_{1} \\ {M}_{i}^{t} , & else\end{matrix} \qquad ( 11 )$$

wherein r₂ is a random number within 0˜1; when r₂ is less than c₁, the particle is crossed with the individual historical optimal solution. The idea of the crossover operation of particle and individual historical optimal solution is as follows: the components that are in the same position between the current particle and individual historical optimal solution are kept, one component is randomly selected among the other components, and a new placement position is searched for the component;
finally, social experience learning is performed, and an update formula is defined as follows:

$${CG}_{i}^{t} = {C}_{2} ( {CP}_{i}^{t} , {c}_{2} ) = \{ \begin{matrix}{C}_{2} ( {CP}_{i}^{t} , {c}_{2} ) , & {r}_{3} < {c}_{2} \\ {CP}_{i}^{t} , & else\end{matrix} \qquad ( 12 )$$

wherein r₃ is a random number within 0˜1, and, when r₃ is less than c₂, the particle is crossed with the global optimal solution: and the idea of crossing the particle and the global optimal solution is the same as that of C₁.

In this embodiment, preferably, the fault connection and fault cell are marked as unavailable cells according to the physical fault mapping diagram. If the fluid passes through the unavailable cell, the present invention proposes two fault-tolerant routing schemes: 1) constructing a new alternative path using its standby cells according to the bidirectional redundancy technology, and 2) converting cells occupied by other components which have finished the operation into spare cells according to the cell function transformation technology, thus opening a passable path for the current fluid.

In this embodiment, because a plurality of reagents are transported from the input port to the component, an improper reagent input sequence would result in a plurality of fluid conflicts. Therefore, in the present invention, considering the reagent input sequence and aiming to minimize bioassay completion time, a total length of transport path and the number of fluid conflicts, an A* fault-tolerant routing algorithm based on an optimal input sequence is proposed. Furthermore, designed in the present invention is a new routing cost to increase a cost of routing scheme with fluid conflicts, which is calculated as:

$$G ( p ) = \{ \begin{matrix}( \vert {x}_{p} - {x}_{s} \vert + \vert {y}_{p} - {y}_{s} \vert ) \times l , \\ ( \vert {x}_{p} - {x}_{s} \vert + \vert {y}_{p} - {y}_{s} \vert ) \times 2 l , ∃\end{matrix} \qquad ( 13 )$$

wherein, (xₚ, yₚ) and (xₛ, yₛ) respectively represent coordinates of a current cell p and a starting point cell s, l represents a cell length passing through a FPVA cell, and cell(s, p) represents a set of routing cells passed through from the starting point cell s to the current cell p.

In this embodiment, the routing optimization strategy based on priority specifically comprises:
fluid transport priorities are defined:

| Priority (from high to low) | Fluid type |
|---|---|
| Level 1 | A fluid with earlier operating time |
| Level 2 | A fluid further from a target component |
| Level 3 | A fluid in a transport state |
| Level 4 | A fluid that has been stored for a longer |
| | period of time |

In the event of a fluid conflict, a fluid with a lower priority would change direction or be stored in a standby cell, waiting for a fluid with a higher priority to preferentially pass. In particular, if a fluid is transported to a cell that is already occupied by another fluid, the fluid in the cell would pass through first, regardless of priority.

In this embodiment, the routing optimization strategy based on backtracking specifically comprises: the following procedure is repeated until conflicts are avoided: when a fluid conflict occurs at one moment, backtracking to a previous moment and searching for an available standby cell to store critical fluids (i.e., the fluids that cause the conflict). Meanwhile, the remaining fluids continue to be transported according to the fluid transport priority.

The foregoing descriptions are merely preferred embodiments of the present invention, and all equivalent changes and modifications made according to the scope of the present invention for patent application shall fall within the scope of the present invention.

What is claimed is:

1. A fault-tolerant oriented physical design method for fully programmable valve array biochips, wherein the method comprises the following steps:
step S1: constructing component placement constraints, and performing a dynamic fault-tolerant placement based on a dynamic constraint placement algorithm based on a particle swarm optimization combined with a dynamic fault-tolerant technology, wherein a fault-tolerant placement scheme without component conflicts is obtained;
step S2: considering an input sequence of reagents, and performing a dynamic fault-tolerant routing based on an A* fault-tolerant routing algorithm based on an optimal input sequence combined with a dynamic fault-tolerant technology; and
step S3: further processing fluid conflicts occurring in the dynamic fault-tolerant routing through a routing optimization strategy based on priority and backtracking, wherein a fault-tolerant routing scheme without fluid conflicts is obtained.

2. The fault-tolerant oriented physical design method according to claim 1, wherein the component placement constraints comprise:
a non-overlapping constraint set of components is introduced to limit two components to be not overlapped to prevent parallel components from occupying the same cell:
$${x}_{ld}^{i} \geq {x}_{ru}^{j} - {c}_{1} \times K \qquad ( 1 )$$
$${x}_{ru}^{i} \leq {x}_{ld}^{j} + {c}_{2} \times K \qquad ( 2 )$$
$${y}_{ld}^{i} \geq {y}_{ru}^{j} - {c}_{3} \times K \qquad ( 3 )$$
$${y}_{ru}^{i} \leq {y}_{ld}^{j} + {c}_{4} \times K \qquad ( 4 )$$
$${\sum }_{k = 1}^{4} {c}_{k} = 3 \qquad ( 5 )$$
wherein, (x_{id}ⁱ, y_{id}ⁱ) and (xᵣᵤⁱ, yᵣᵤⁱ) represent lower-left and upper-right coordinates of the components bound by an operation Oᵢ respectively, and K is a maximum constant, and cₖ is an auxiliary binary variable, wherein k=1, 2, 3, 4; and, when cₖ is 0, a corresponding constraint is satisfied;
a component overlapping permission is introduced to allow the components to overlap, wherein an intermediate fluid is allowed to proceed to a next operation without transport; the component overlapping permission is implemented by adding an auxiliary binary variable c₅ in (5):
$${\sum }_{k = 1}^{4} {c}_{k} = 3 + {c}_{5} \qquad ( 6 )$$
c₅ is set to be 1 when two components are not concurrent, wherein each cₖ, k=1, 2, 3, 4 must be 1 to allow two devices to overlap.

3. The fault-tolerant oriented physical design method according to claim 1, wherein the dynamic constraint placement algorithm based on the particle swarm optimization comprises:
each particle is encoded as (pos₁, ⋅ ⋅ ⋅ , posₙ, f), wherein n is a number of components, posᵢ represents location information of a component Mᵢ, wherein posᵢ is uniquely determined by a lower-left coordinate and shape of the component, and f represents an adaptation value of particles,
(1) an adaptation value function is defined as follows:
$$Fitness = {α}_{1} \times OL - {α}_{2} \times A - {α}_{3} \times D - β \qquad ( 7 )$$
wherein, OL is a number of overlapping cells of parent-child components, A is a chip area occupied by non-parent-child components, D is a distance from an output fluid to an output port, α₁,α₂,α₃ are weights adding up to 1, and β is a penalty term for violating the component placement constraints, wherein β is defined as follows:
$$β = \{ \begin{matrix}K , {\sum }_{k = 1}^{4} {c}_{k} = 4 ∧ {c}_{5} = 0 \\ 0 , else\end{matrix} \qquad ( 8 )$$
wherein K is a maximum constant, and
$${\sum }_{k = 1}^{4} {c}_{k} = 4 ∧ {c}_{5} = 0$$
represents overlapping of concurrent components;
(2) an optimal solution is iteratively searched in a solution space according to the adaptation value of particles; in each round of iterative search, particles are updated according to historical optimal solutions and a global optimal solution; and an updating formula of an ith particle Pᵢ^{t} in a t round of iteration is defined as follows:
$${P}_{i}^{t} = {C}_{2} ( {C}_{1} ( M ( {P}_{i}^{t - 1} , w ) , {c}_{1} ) {c}_{2} ) \qquad ( 9 )$$
wherein M represents a mutation operation, an inertia weight W represents a probability of particle mutation, and C₁ and C₂ represent a crossover operation between a particle and an individual historical optimal solution and a global optimal solution respectively, and learning factors c₁ and c₂ represent crossover probabilities between the particle and the individual historical optimal solution and the global optimal solution respectively;
(3) firstly, a speed update is carried out, and an update formula is defined as follows:
$${M}_{i}^{t} = M ( {P}_{i}^{t - 1} , w ) = \{ \begin{matrix}M ( {P}_{i}^{t - 1} , w ) , & {r}_{1} < w \\ {P}_{i}^{t - 1} , & else\end{matrix} \qquad ( 10 )$$
wherein r₁ is a random number within 0˜1; when r₁ is less than w, the particle mutates;
the mutation operation is as follows: a component is randomly selected and a new available cell is found for the component as a new placement location of the component;
secondly, a self-cognitive learning is carried out, and an updated formula is defined as follows:
$${CP}_{i}^{t} = {C}_{1} ( {M}_{i}^{t} , {c}_{1} ) = \{ \begin{matrix}{C}_{1} ( {M}_{i}^{t} , {c}_{1} ) , & {r}_{2} < {c}_{1} \\ {M}_{i}^{t} , & else\end{matrix} \qquad ( 11 )$$
wherein r₂ is a random number within 0˜1; when r₂ is less than c₁ the particle is crossed with the individual historical optimal solution; an idea of the crossover operation of particle and individual historical optimal solution is as follows: the components are kept, wherein the components are in the same position between the current particle and individual historical optimal solution, one component is randomly selected among the other components, and a new placement position is searched for the component;
finally, a social experience learning is performed, and an update formula is defined as follows:
$${CG}_{i}^{t} = {C}_{2} ( {CP}_{i}^{t} , {c}_{2} ) = \{ \begin{matrix}{C}_{2} ( {CP}_{i}^{t} , {c}_{2} ) , & {r}_{3} < {c}_{2} \\ {CP}_{i}^{t} , & else\end{matrix} \qquad ( 12 )$$
wherein r₃ is a random number within 0˜1, and, when r₃ is less than c₂, the particle is crossed with the global optimal solution; and an idea of crossing the particle and the global optimal solution is the same as that of C₁.

4. The fault-tolerant oriented physical design method according to claim 1, wherein the fault-tolerant placement scheme without the component conflicts comprises:
(1) constructing a new alternative path by using standby cells of an unavailable cell according to a bidirectional redundancy technology; and
(2) converting cells occupied by other components into spare cells according to a cell function conversion technology, wherein the components have finished the operation, thus opening a passable path for a current fluid.

5. The fault-tolerant oriented physical design method according to claim 1, wherein the A* fault-tolerant routing algorithm based on the optimal input sequence comprises:
considering a reagent input sequence and aiming to minimize bioassay completion time, a total length of transport path and a number of fluid conflicts, a formula (13) is configured to calculate a new routing cost to increase a cost of routing scheme with fluid conflicts, the new routing cost is calculated as:
$$G ( p ) = \{ \begin{matrix}( \vert {x}_{p} - {x}_{s} \vert + \vert {y}_{p} - {y}_{s} \vert ) \times l \\ ( \vert {x}_{p} - {x}_{s} \vert + \vert {y}_{p} - {y}_{s} \vert ) \times 2 l , ∃\end{matrix} \qquad ( 13 )$$
wherein, (xₚ, yₚ) and (xₛ, yₛ) respectively represent coordinates of a current cell p and a starting point cell s, l represents a cell length passing through a FPVA cell, and cell(s, p) represents a set of routing cells passed through from the starting point cell s to the current cell p.

6. The fault-tolerant oriented physical design method according to claim 1, wherein the routing optimization strategy based on priority comprises:
fluid transport priorities are defined,
level 1: a fluid with earlier operating time;
level 2: a fluid further from a target component;
level 3: a fluid in a transport state;
level 4: a fluid stored for a longer period of time;
in an event of a fluid conflict, a fluid with a lower priority would change a direction or be stored in a standby cell, waiting for a fluid with a higher priority to preferentially pass.

7. The fault-tolerant oriented physical design method according to claim 6, wherein if a fluid is transported to a cell occupied by another fluid, the fluid in the cell would pass through first, regardless of priority.

8. The fault-tolerant oriented physical design method according to claim 1, wherein the routing optimization strategy based on backtracking comprises: the following procedure is repeated until conflicts are avoided: when a fluid conflict occurs at one moment, backtracking to a previous moment and searching for an available standby cell to store critical fluids; meanwhile, remaining fluids continue to be transported according to a fluid transport priority.
